(19) United States
(12) Patent Application Publication
(10) Pub. No.: US 2024/0225076 A1
(43) Pub. Date: Jul. 11, 2024

(54) A MACHINE FOR PREPARING SNACKS BASED ON PUFFED CEREALS AND THE LIKE

(71) Applicant: IDEALMAC S.R.L., Torino (IT)

(72) Inventors: Guido BARET, Torino (IT); Giovanni LAVISTA, Torino (IT)

(21) Appl. No.: 18/562,812

(22) PCT Filed: May 26, 2022
(86) PCT No.: PCT/IB2022/054945

§ 371 Date: Nov. 20, 2023

(30) Foreign Application Priority Data
May 26, 2021 (IT) 102021000013730
May 26, 2021 (IT) 102021000013736
May 26, 2021 (IT) 102021000013742
Jul. 29, 2021 (IT) 102021000020306

(51) Int. Cl. A23P 30/36; A23P 30/10; A23P 30/38

(52) U.S. Cl. CPC A23P 30/36; A23P 30/10; A23P 30/38

(57) ABSTRACT

A machine for preparing snacks comprises a source of compressed gas (CA) and pneumatic actuators (100₁, 200₁, 100₂, 200₂) for causing displacements among an upper mould plate (UP), a lower mould plate (LP) and an intermediate mould plate (IP). The pneumatic actuators (100₁, 200₁, 100₂, 200₂), comprise a compression pneumatic-cylinder (100₁, 100₂) having a plunger (102) delimits a first and second chambers (A, B) having variable volume. The second chamber (B) is connected with the source of compressed gas (CA) via a first duct (L₁, La₁, La₂), the first chamber (A) is connectable to the second chamber (B) through a second duct (SLa, SLb), and the first chamber (A) is also connected to the second chamber (B) via a third duct (EL). A flow-regulator device (FR₁, FR₂) is set on the second duct (SLa, SLb), and a shut-off member (CV₁, CV₂) is set on the third duct (EL).

### TECHNICAL FIELD

The present invention concerns the technical field of equipment for the food industry and has been developed with particular attention being paid to machines for the production of snacks based on cereals or the like, substantially in the form of more or less thick wafer. The invention is suitable for use in the production of snacks based on “puffed” or “exploded” cereals, that is, of the “puffed” or “popped” type, respectively, according to an Anglo-Saxon terminology used in the sector.

### State of the Art

Machines of the type indicated generally include heated presses, configured to compress and heat a dose of raw material, in order to obtain a wafer. Depending on the type of driving of the presses, the machine can produce wafer of different thickness: in the field, the thickest products are usually referred to as “cakes”, while the thinner ones as “chips”, as they are similar, in fact, to a potato chip.

The production of cereal cakes, for example rice, provides that the cereal grains are subjected to a phase of compression and heating, so as to expand considerably when the press is reopened: the cake will therefore have a low density compared to the original grains, due to their expansion of volume, and a certain thickness. The same machines can also be used for the production of chips: in this case, a second compression phase is usually provided, which follows the expansion of the product at the end of the first compression phase, substantially in order to thin the wafer and form the chip.

The presses used typically include mould plates that can be moved so that they can be brought closer to each other and spaced apart from each other, and often even with respect to a fixed mould plate. The actuation is commonly carried out by hydraulic cylinders, or by pneumatic cylinders, or by electric motors.

Hydraulically operated presses have the advantage of allowing relatively fast actuations: given that the fluidic circuit is closed, the relevant cylinders are able to react very quickly and accurately to the actuation commands. Thanks to these characteristics, a suitable control of the supply of the hydraulic cylinders of the presses enables to precisely vary the stroke of the mould plates, also in order to vary the thickness of the products to be obtained, whether they are cakes or chips, for the purpose of possible production changes. However, the hydraulic drive is inherently unsuitable for use in an environment where hygienic conditions suitable for the treatment of food products are required (think of possible phenomena of leakage and exudation of the cylinders). Pneumatically operated presses do not present the above problems, but have a basically open compressed gas supply circuit: for this reason, in order to allow very rapid actuations to be carried out, when necessary, special expedients must be provided, such as the use of two cylinders in series for the operation of a single mould plate.

The machines according to the prior art technique have certain drawbacks.

The first drawbacks are related to the general conformation of the machine, whose supporting structure generally provides for a base from which a columnar element rises, which supports the processing group, including the heated press. This type of structure implies that the working environment must be equipped with fume and cooking vapor extraction systems which are oversized, and that often do not allow to avoid the dispersion of part of these fumes or vapours in the same working environment. For the same reason—and even if the aforementioned “columnar” structure must have associated thereto a grilled accident prevention protection system—in the known machines possible scraps or processing powders (such as crumbs, blowing burrs, unexploded cereal grains, etc.) are dispersed on the surrounding flooring, so increasing the slipperiness of the flooring itself and forcing the operators to frequently clean the work environment.

Other drawbacks are related to the laboriousness and the time required to prepare the machine differently in case of changes in the production batches or production orders, that is, the type of products to be obtained from the machine. These operations involve the replacement of a dosing plate, i.e., a member responsible for adducing to the press the dose of cereal or the like necessary for the production of the product of interest. The task of replacing this plate is usually relatively time-consuming and laborious.

Other drawbacks are related to the difficulty, in pneumatically operated machines, of regulating the expansion of the product to be obtained, if not by acting on the pressure of the compressed air. The air, however, is compressible and this generally complicates obtaining an adequate and constant operating precision. Even by increasing the pressure at the inlet of the pneumatic cylinders, for example in order to obtain a greater expansion of the cereals subjected to cooking and compression, it is possible that different displacement speeds are determined between an upper mould plate and a lower mould plate, with the consequent risks of obtaining inconsistent products, or in any case not expanded in a homogeneous way.

Other drawbacks of pneumatically operated presses are related to the fact that the compressed gas, typically air, is compressible and this does not allow to vary in a sufficiently precise and constant way the stroke of the mould plates via the simple control of the supply of the corresponding pneumatic cylinders, in case of production changes for products of different thickness. For this reason, in order to allow the aforementioned adjustments necessary for the purposes of the aforementioned production changes, it is necessary to intervene mechanically on the machine. For this purpose, the stem of the cylinder closest to the mould plate can be connected to the plate itself by means of a mechanical coupling of an adjustable type, to allow a fine or precision adjustment of the operating position of the mould plate, when the stem is at the end of its advancing stroke. Some of these systems of mechanical adjustment provides, for example, a part with a male thread defined or associated with the proximal end of the stem of a cylinder, on which a bushing with a female thread is engaged in an adjustable way, this bushing being used to secure the mould plate to the aforementioned stem. These adjustments are however laborious and require significant time, to prearrange the machine differently in case of changes in production batches or production orders.

### AIM AND SUMMARY

In its general terms, the present invention aims to obtain a machine of the type indicated at the beginning which enables to solve one or more of the aforementioned drawbacks.

In this context, one aim of the invention is to obtain a machine of the type indicated, in particular a pneumatically operated machine, wherein a high precision of movement of one or more mould plates is ensured, without having necessarily to act on the supply pressure of the pneumatic cylinders. Another aim of the invention is to obtain a machine of the type indicated having a structure that allows for increasing the healthiness of the working environment. A further aim of the invention is to obtain one such a machine wherein the operations of production change, in particular in relation to the thickness of the snacks to be obtained, can take place more quickly and with greater simplicity than the known machines.

One or more of the abovementioned aims, and other aims which will become clear thereafter, is achieved or are achieved, according to the invention, by a machine having the characteristics indicated in the attached claims. The claims form an integral part of the technical teaching that is provided herein in relation to the invention.

### BRIEF DESCRIPTION OF THE DRAWINGS

Further aims, characteristics and advantages of the invention will result from the following description, made with reference to the attached drawings, provided by way of non-limiting example only, wherein:

FIG. 1 is a schematic perspective view of a machine for the production of snacks, according to possible embodiments;

FIGS. 2, 3 and 4 are partially exploded schematic views of the machine of FIG. 1;

FIG. 4a is a simplified representation in section of a lower part of a machine according to possible embodiments;

FIG. 5 is a schematic view in side elevation of a processing unit of a machine for the production of snacks, according to possible embodiments;

FIG. 6 is a partial and schematic perspective view of the processing unit of FIG. 5, with some components removed,

FIG. 7 is a detail in larger-scale of FIG. 6;

FIG. 8 is a schematic side section intended to exemplify the basic scheme of a press of the processing unit of FIGS. 4-5;

FIGS. 9a-9k are schematic representations, similar to that of FIG. 8, intended to exemplify a possible processing sequence of the press of FIG. 8;

FIG. 10 is a schematic representation of a basic pneumatic scheme for the operation of a processing unit of the type exemplified in FIG. 5; and

FIG. 11 is a view similar to that of FIG. 5, of a processing unit of a machine for the production of snacks, according to possible alternative embodiments.

### DESCRIPTION OF PREFERRED EMBODIMENTS

The reference to an embodiment within this description indicates that a particular configuration, structure, or characteristic described in relation to the embodiment is comprised in at least one embodiment. Thus, phrases such as “in one embodiment”, “in various embodiments” and the like, possibly present in different places of this description, are not necessarily referred to one the same embodiment. In addition, particular conformations, structures or characteristics defined within this description may be combined in any appropriate way in one or more embodiments, even different from those depicted. The numerical and spatial references (such as “upper”, “lower”, “high”, “low”, etc.) as used herein are for convenience only and therefore do not define the sphere of protection or the scope of the embodiments. The same reference numbers are used in the figures to indicate similar or technically equivalent elements. In the following, the terms “upper” and “lower”, when referred to internal chambers with variable volume of the pneumatic cylinders described below, are meant to identify the chamber which is farer and closer, respectively, to a moulding assembly. In this description, the term “quick change” (device) is meant to identify a mechanical coupling device used to mutually constrain in a separable manner the stem of an actuator, in particular a linear actuator, and a dosing plate of the type indicated above, wherein said device is configured for enabling the separation between the stem and the plate without the use of tools or implements, such as wrenches, or Allen wrenches, or screwdrivers, or the like.

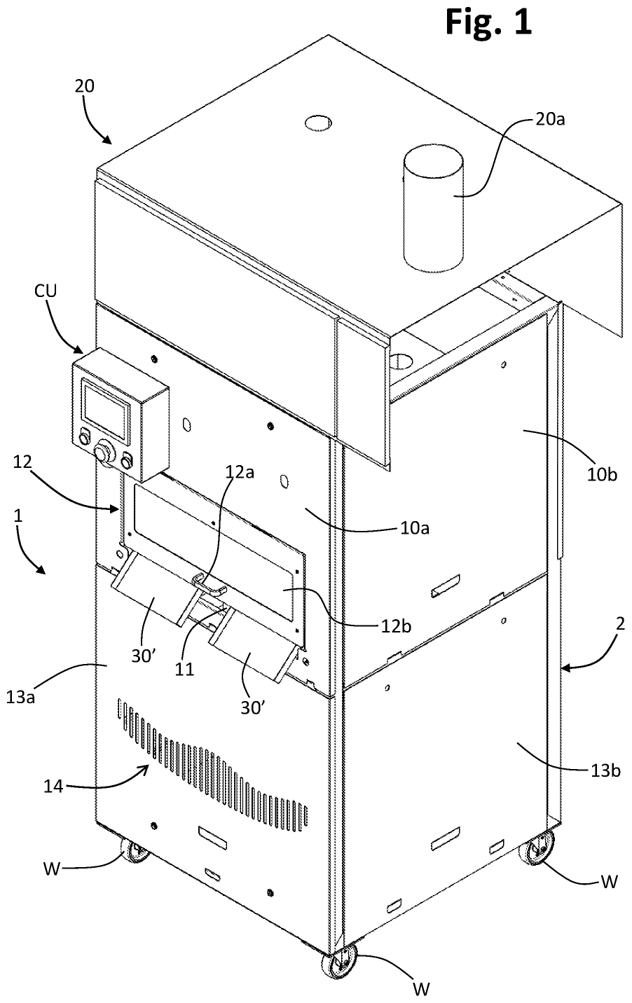

Referring initially to FIG. 1, reference 1 indicates as a whole a machine for the production of cereal-based snacks. The machine 1 is suitable for the production of puffed or popped (exploded) cereal wafer, in the form of cakes or chips.

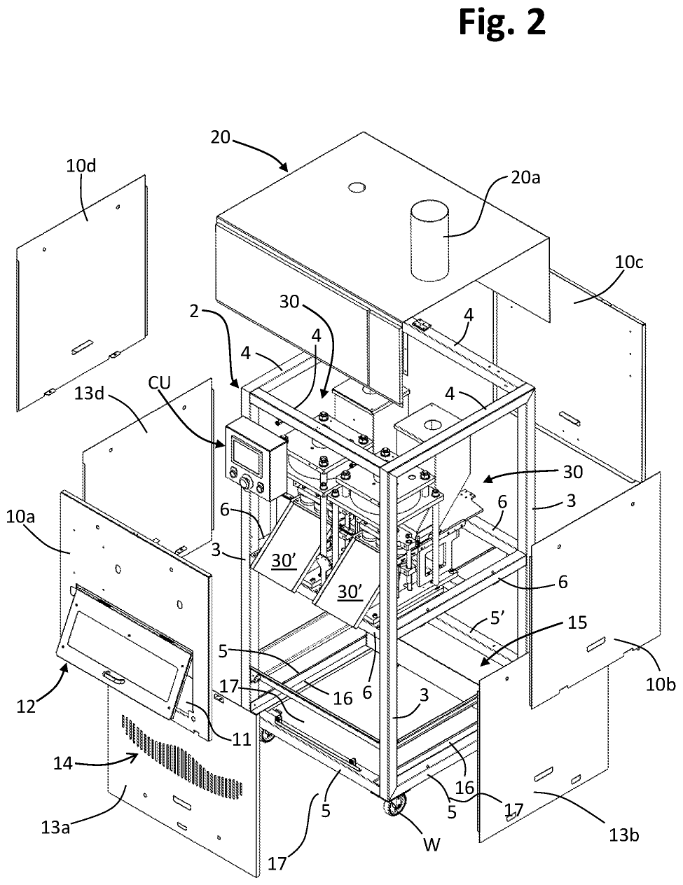

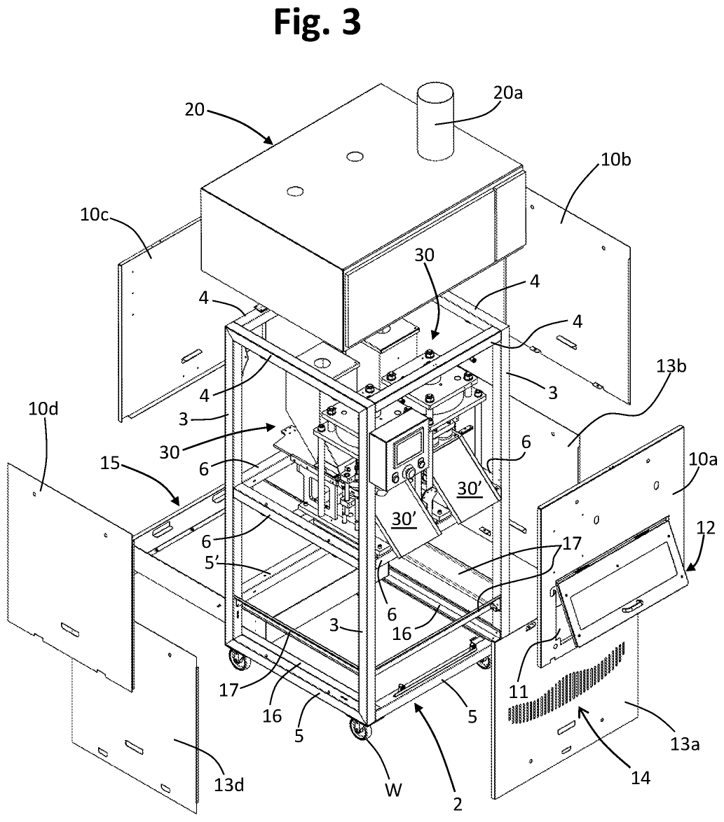

Referring also to FIGS. 2-4, the machine 1 has a load-bearing structure which includes a frame, indicated with 2 as a whole, having a substantially polyhedric shape, preferably substantially parallelepiped, formed by a plurality of upright and transverse structural elements, later identified for simplicity as “uprights” and “crossbars”, preferably made of metal material (for example stainless steel). In the depicted example four uprights 3 are provided, which are connected, at the corresponding upper and lower ends, by four lower crossbars 4 and four upper crossbars 5. In various embodiments, the load-bearing structure represented by the frame 2 therefore includes a structural base (here formed by the lower crossbars 4) and a structural top (here formed by the upper crossbars 5), which are connected to each other by a plurality of structural uprights (here represented by the uprights 3).

The load-bearing structure represented by frame 2, or the structural base thereof, can be equipped with lower pivoting wheels W, in order to allow a manual displacement of the machine, if necessary. Preferably, at least two of the wheels W are equipped with a brake.

In accordance with an important aspect, in various embodiments, the frame 2 includes an anchoring and supporting structure, in an intermediate position with respect to the aforementioned structural base and top, for a processing assembly of the machine 1, which preferably comprises two independent processing units, such as those indicated with 30 in the figures. Referring to the example illustrated, in various preferential embodiments, the uprights 3 are connected, in an intermediate zone thereof, by means of four intermediate load-bearing crossbars 6, which obtain the aforementioned anchoring and supporting structure.

According to an important aspect, in various embodiments, at least the region of the frame 2 which extends between the upper crossbars 4, or the top, and the crossbars 6, or the intermediate structure for anchoring and supporting, is shielded or closed peripherally by a series of substantially closed upper guards or panels, i.e., not having a grid shape, which are removably coupled to the corresponding portions of the frame 2. In order to facilitate their removal, these upper panels can be provided with slots that act as a handle. The upper panels are preferably made of metal material, for example stainless steel.

In the example there are therefore four upper panels 10a-10d, of which the front one, designated with 10a, is preferably provided with an opening 11. At the opening, a 12 door is mounted on panel 10a, preferably hinged at its upper edge, and provided with a handle, designated with 12a only in FIG. 1. The door 12 is preferably equipped with an inspection window, formed with a sheet of transparent material, indicated with 12b only in FIG. 1. The dimensions in height of the opening 11 of the panel 10a are greater than those of the door 12, so that from the lower part of the opening itself, not covered by the door 12, there protrude means for evacuating the wafer, here represented by two inclined slides designated by 30′, one for each processing unit 30. The part of the opening 11 which is not covered by door 12 has in any case a reduced height.

The presence of the door 12 allows, through the window 12b, to visually control the operation of the units 30, and possibly access at least to the mould plates of the units 30, in case minor interventions are required (such as the removal of a stranded wafer or the accumulations of burned cereals at a press of the units 30, or for a quick cleaning of the inner surface of the window 12a). The door 12 has preferably associated thereto a safety sensor, such as a microswitch, set up in the electrical circuit of the machine 1 in such a way that, in the event of opening the door itself, the operation of the machine is immediately interrupted. In case of more substantial maintenance of the machine it is possible to proceed with the removal of one or more of the panels 10a-10d from the frame 2.

The fact that the panels 10a-10d are substantially closed, that is, not grilled, allows—in addition to fulfilling an accident prevention protection—to contain the fumes and/or cooking vapours that develop during the operation of the machine 1. The panels 10a-10d allow these fumes and/or vapours to be conveyed upwards, towards the upper end of the machine, that is, the structural top, at which a hood can be mounted, such as the one indicated with 20, equipped with a fitting 20a for connection to a suction and/or evacuation system.

According to an important aspect, in various embodiments, the region of frame 2 which extends between the lower crossbars 4, or the structural base, and the intermediate anchoring and supporting structure, here formed by the crossbars 6, is shielded or closed peripherally, by means of a series of substantially closed lower guards or panels, i.e., not having a grid conformation, which are removably coupled to the corresponding portions of the frame 2. In order to ease their removal, these lower panels can also be equipped with slots that act as a handle. The lower panels are preferably made of metal material, for example stainless steel.

In the example three lower panels are shown, designated by 13a, 13b and 13d, —13d, of which at least one—preferably the front one indicated with 13a—can be equipped with a series of openings 14 for ventilation or suction, here in the form of slits. The example does not show a lower panel in the rear position (i.e., below the upper panel 10c), since in this position an electric and pneumatic control panel is mounted, not represented; however, it will be appreciated that a lower panel can be provided in place of the aforementioned control panel, if equipped with one or more openings for the passage of at least one power supply cable and at least one pneumatic supply duct.

The presence of the openings 14 allows adequate ventilation of the interior of machine 1, which—as seen—is delimited peripherally by the aforementioned panels and the aforementioned electrical panel. The openings 14 also allow, in particular in presence of the hood 20, an adequate intake of air from the outside, and therefore an internal air exchange; preferably, the relative position between the openings 14 and the fitting 20a of the hood 20 is designed to induce a flow of air that invests the units 30, for ventilation purposes.

The fact that panels 13a, 13b and 13d and the aforementioned electrical panel are substantially closed, that is, not grid-like, allows—in addition to fulfilling an accident prevention protection—to contain inside the machine the scraps and/or the powders of cereal or the like (such as crumbs, blowing burrs, grains of unexploded cereals, etc.) that originate during the operation of the machine 1. The panels 13a, 13b and 13d and the inner side of the control panel allow these scraps and/or powders to be conveyed downwards, containing their dispersion in the external environment.

According to an important aspect, in various preferential embodiments, in particular in presence of the lower panels and/or the control panel, in the lower part of the structure of the machine a drawer is provided, for collecting the aforementioned scraps and/or powders. Such a drawer is indicated with 15 in FIGS. 2-4. As it can be noted, the drawer 15 is therefore located under the processing assembly of the machine 1 and has lateral dimensions such as to extend over substantially the entire cross-section of the load-bearing structure 2 as identified by the uprights 3. In this way, the drawer 15 allows to collect the aforementioned scraps and/or powders (crumbs, blowing burrs, grains of unexploded cereals, etc.) that originate as a direct effect of the operation of a processing unit 30, that is, before obtaining the cakes or the like. Moreover, as is apparent, the drawer 15 also allows to collect those cakes that, coming out of a processing unit 30, could accidentally fall on the sides of the corresponding slide 30′.

For this purpose, preferably, sliding guides for the drawer 15 are associated to the load-bearing structure represented by the frame 2, in order to allow an easy extraction of the drawer itself, for the purpose of evacuating scraps and/or powder. At least some of the guides provided—such as those indicated with 16, can be associated to two of the lower crossbars 5 parallel to each other.

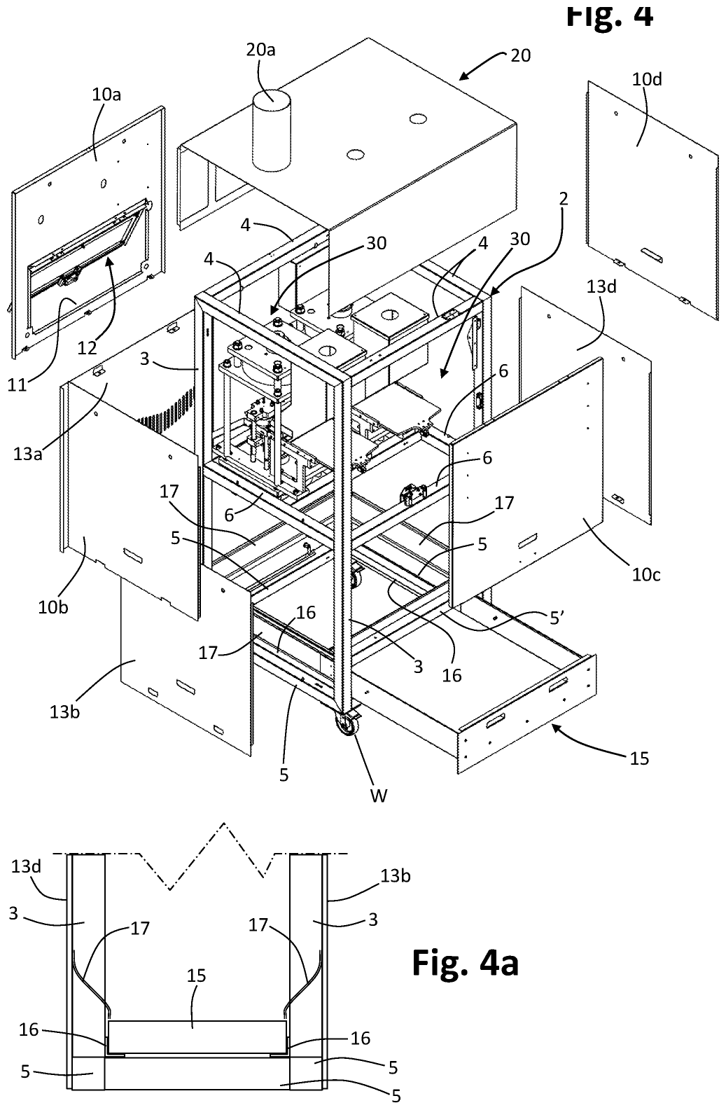

In various preferential embodiments, within the machine deflector elements are provided, aimed at conveying towards the inside of the drawer 15 that part of scraps and/or powders which might come into contact with the inner side of the lower panels and the control panel, and which—by slipping on said panels by gravity—could cause jamming of the drawer; therefore, the aforementioned deflector elements are mounted higher than the drawer. In the non-limiting example shown, the above deflector elements are indicated with 17 in FIGS. 2-4, and are each fixed between two uprights 3 other than those that delimit laterally the opening for the drawer 15. Basically, the deflector elements 17 define a chute or an inclined plane that extends approximately between the outer side and the inner side of the upright in question. The concept is exemplified, in an extremely schematic form in FIG. 4a, where the two deflector elements 17 are represented at the lateral flanks of the machine, that is, the lower panels 13b and 13d, and from this figure it can be imagined how the presence of these deflector elements allows to convey scraps and/or powders to the inside of the drawer, so avoiding the risk of deposits thereof on the guides 16.

In the example, the drawer 15 can be opened/closed at the back of the machine, but this is not an essential feature. In the case exemplified, the control panel, or the possible rear lower panel that replaces it, will clearly be of a reduced height as compared to the other lower panels, in order to allow housing and sliding of the drawer 15. Always referring to the non-limiting example, in order to allow the fixing in position of the control panel or other panel, an additional crossbar 5′ can be provided, in an intermediate position between the crossbars 5 and 6 that are located at the back of the machine.

The panels 10a-10d and/or 13a, 13b and 13d are preferably non-transparent panels.

The machine 1 is equipped with a control unit, designated by CU, which manages the operation of the electrical and pneumatic components of the machine. The control unit CU can be implemented via a PLC equipped with a user interface, such as a touch screen display, and memory means that contain the operating software and the possible storage of recipes.

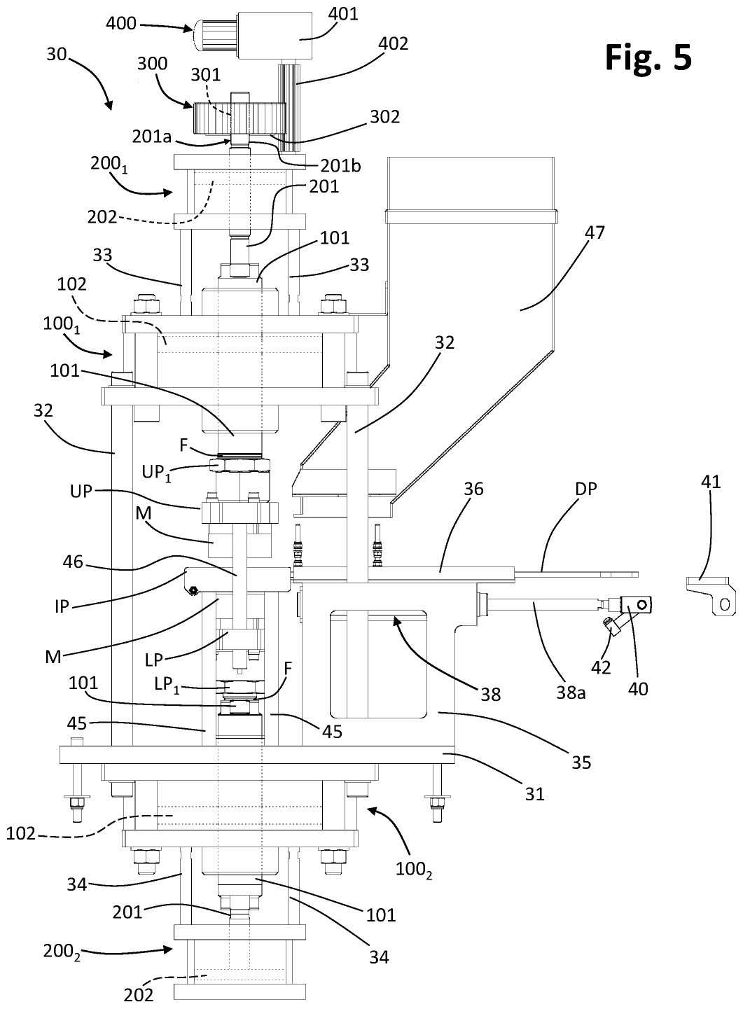

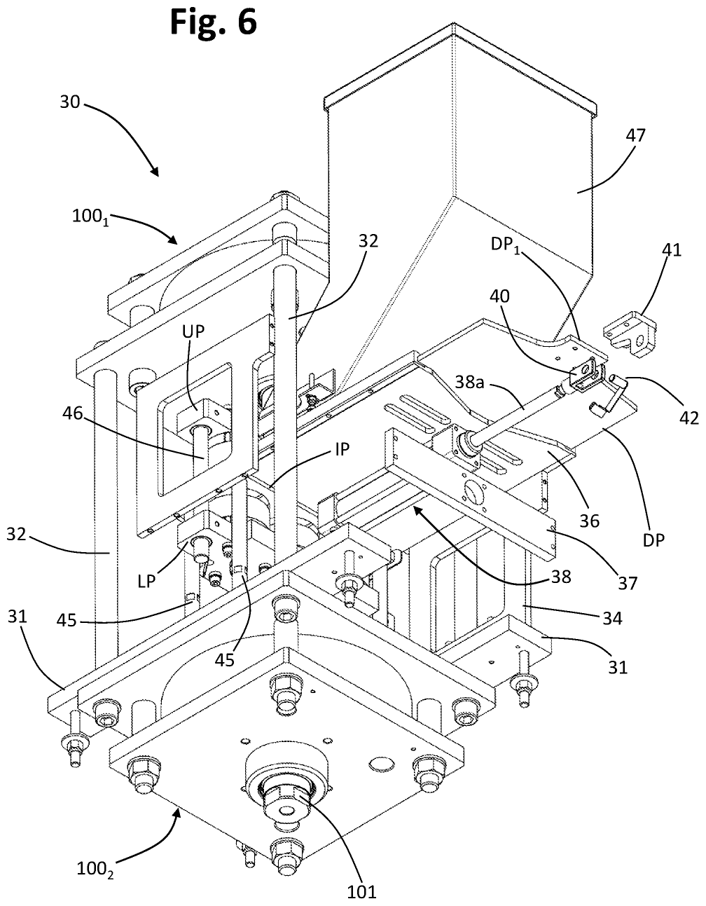

In FIGS. 5 and 6 a processing unit 30 is shown with different views; as will be seen, the processing unit comprises actuators means, in particular pneumatic actuator means, which are controllable to cause relative linear displacements between two or more mould plates, in particular an upper mould plate, a lower mould plate and an intermediate mould plate, in order to compress a dose of cereal in order to obtain the product.

In various embodiments, the unit 30 has a respective load-bearing structure, provided for being fixed to the anchoring and supporting structure of the frame 2, that is, the structure formed by the intermediate crossbars 6, which is configured in such a way that the unit is suspended with respect to the anchoring and supporting structure. In preferential embodiments, such a structure of the unit 30 includes two side metal plates 31, in parallel positions, the ends of which are suitable to be secured—for example, by threaded members—between two opposite crossbars 6. From the two plates 31 there rise respective pairs of rods or the like 32, which support therebetween the structure of an upper compression cylinder 100₁. From the structure of the cylinder 100₁ there rise in turn rods or the like 33, which support therebetween the structure of an upper movement or displacement cylinder 200₁. The compression cylinder 100₁ has a through-stem 101, at the upper or proximal end of which the stem 201 of the displacement cylinder 200₁ is mechanically coupled. Note that in FIG. 6 the representation of the upper displacement cylinder, as well as of a lower displacement cylinder mentioned below, is omitted for the sake of clearer representation.

Under the side plates 31 there is associated the structure of a double-acting lower compression cylinder 100₂. From the structure of the cylinder 100₂ there extend downwards rods or the like 34, which support therebetween the structure of a double-acting lower displacement cylinder 200₂. Also in this case, the compression cylinder 100₂ has a through-stem 101, at the upper or proximal end of which the stem 201 of the displacement cylinder 200₂ is mechanically coupled. As it will be seen, each pneumatic displacement cylinder 200₁ or 200₂ is controllable to cause a displacement of a plunger of the corresponding pneumatic compression cylinder 100₁ or 100₂ between a retracted position and an advanced position, and the pneumatic compression cylinder 100₁ or 100₂ is controllable to exert compression on a dose of cereal P after its plunger has been brought to the said advanced position.

As it can be seen, the provision of the side plates 31 basically enables to suspend the unit 30 inside the supporting structure of the machine.

The unit 30 comprises a dosing plate DP, which defines at least one dosage through opening, and which is movable between:
a backward position, in which the dosage opening receives a dose of cereal from a cereal feeding system, and
a forward position, in which the dosing opening is axially aligned with a through opening of an intermediate mould plate, described below, to position the dose of cereal thereinto.

In the example shown, each side plate 31 bears above a respective vertical side bracket 35, so that between the two brackets 35 guiding means are supported, here represented by a guiding plate 36, to guide the linear movement of the mentioned dosing plate, indicated with DP (note that in FIG. 5, one of the two brackets 35 is shown in exploded view, for the sake of clarity of the drawings). Between the two brackets 35 there extends preferably also a crossbar—indicated with 37 in FIG. 6—for the positioning and/or fixing of a further controllable linear actuator 38, here a pneumatic cylinder (but it could be an electric actuator), used to cause to-and-fro linear displacements of the dosing plate DP between the backward position and the forward position, with respect to the guiding plate 36. The cylinder 38 is preferably set below the dosing plate DP, i.e., the guiding plate 36, substantially parallel thereto.

The cylinder 38 has a stem 38a, to which the dosing plate DP is constrained by a mechanical coupling. With the aforementioned arrangement of the cylinder 38, which is substantially parallel to the dosing plate DP, the stem is also substantially parallel to said plate.

In various particularly advantageous embodiments, the dosing plate DP is of a replaceable type, in particular in order to vary the production batches, and the separable mechanical coupling between the stem 38a of the cylinder 38 and the dosing plate DP is achieved by means of a quick-change device.

In various embodiments, the quick-change device comprises:
a first quick-change element associated to the stem of the linear actuator, having at least one first passage (for example a fork element),
a second quick-change element associated to the dosing plate, having at least one second passage (for example a bracket having a nose engageable in the fork element),
a locking member having a pin portion which is engageable in the at least one first passage and in the at least one second passage, to constrain in a separable way the first quick-change element and the second quick-change element.

Preferably, the locking member further has a coupling portion which is elastically or snap engageable and disengageable with respect to one of the first quick-change element, the second quick-change element and the stem 38a of the linear actuator 38, to prevent an unwanted slipping of the pin portion of the locking member from the at least one first passage and the at least one second passage. Preferably, the aforementioned coupling portion is elastically or snap engageable and disengageable following a stress on the locking member, such as to induce a rotation of the pin portion within the at least one first passage and the at least one second passage.

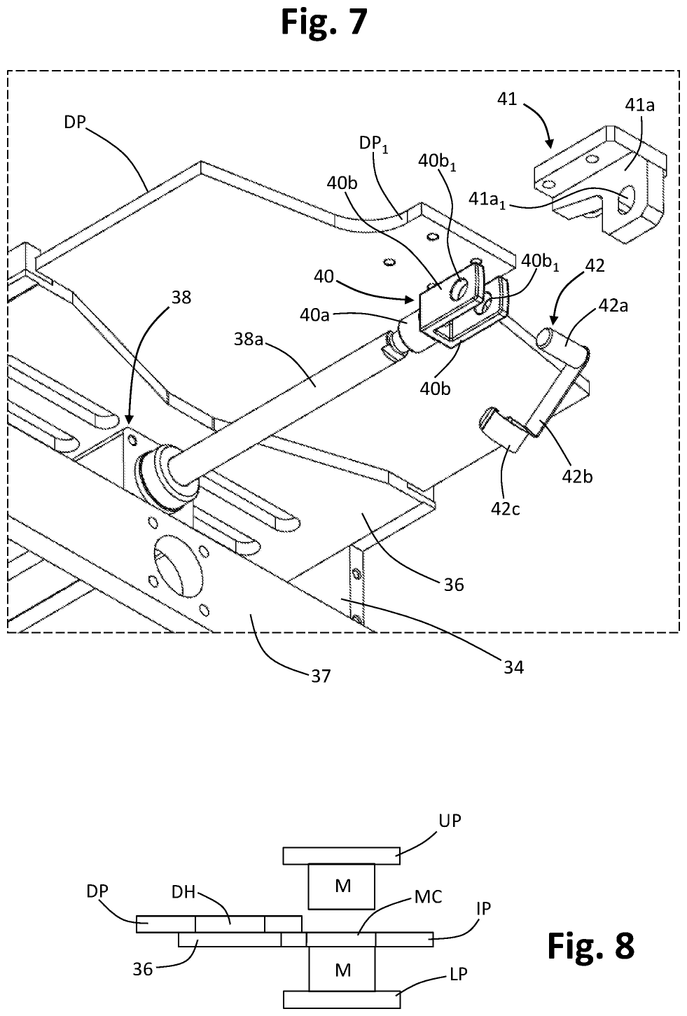

Referring also to FIG. 7, in the example shown, the first quick-change element includes an a generally fork-shaped element 40, preferably made of metal. The fork element 40, preferably provided with a connection portion 40a, for connection to the end of the stem 38a, has two parallel arms 40b between which an engaging portion 41a of a bracket 41, preferably made of metal, is receivable, which obtains the second quick-change element. Preferably, the bracket 41 is secured to the underside of a rear end portion DP₁ of the plate DP, possibly a shaped portion. The arms 40b of the fork element 40 have respective holes 41b₁ aligned with each other, and the portion 41a of the bracket 41 is also provided with a through opening 41a₁. This opening 41a₁ is suitable to be aligned with the holes 40b₁, so as to receive a pin portion 42a of a locking member 42, preferably made of metal, which can be removed in a quick way. In the example, the member 42 has a portion 42b that extends in a radial direction with respect to the pin 42a and that is configured, at the distal end, for elastic or snap coupling with the fork element 40, in particular with its portion 40a. More particularly, in the example, the aforementioned connection portion 40a has a substantially cylindrical shape and the distal end of the portion 42b of the member 42 defines a sort of open collar 42c, i.e., substantially C-shaped, which is elastically or snap engageable on the portion 40a. As it can be imagined, starting from the coupled condition, it is sufficient to stress the portion 42b of the member 42 in the way of inducing a rotation of the pin portion 42a—within the holes 40b₁ of the fork 40 and the opening 41a₁ of the bracket 41—to obtain thereby the release of the collar portion 42c from the portion 40a of the fork element 40, and the consequent possibility of removing the pin 42a from the aforementioned holes and opening. On the other hand, in order to reposition the member 42, it is sufficient to insert the pin 42a between the holes of the fork 40 and the opening of the bracket 41, and then cause it to rotate until the collar portion 42c elastically engages on the portion 40a of the fork element 40. The coupling portion 42c of the member 42 could be configured to engage elastically or in a snap way directly on the stem 38a of cylinder 38.

The arrangement of the quick-change device might at most be different from the one depicted, for example inverted (that is, with the functions of the fork element associated with the plate DP and the functions of the bracket 41 associated with the stem 38a of the linear actuator 38).

From each plate 31 there rises a further pair of rods or the like 45, for the support of an intermediate mould plate, or cooking plate, indicated with IP, which has a plurality of through openings (two of which are partially visible in FIG. 6, not indicated), which ac as female moulds. The intermediate mould plate IP, in a fixed position, has a flat upper surface, on which a corresponding portion of the dosing plate DP is superimposable by sliding, which is provided with respective through openings, these latter opening being suitable for being aligned with the through openings of the stationary plate IP.

UP designated an upper mould plate, bearing a plurality of males or dies M, having a peripheral profile corresponding to that of the through openings of the intermediate plate IP. LP designates a lower mould plate, also bearing a plurality of dies M with a peripheral profile corresponding to that of the through openings of the intermediate plate IP. At least one of the upper plate UP, the bottom plate LP, and the intermediate plate IP has heating means associated thereto. For example, the dies M of the two plates UP and LP are preferably heatable, and are for this purpose internally equipped with electrical resistances, preferably controlled by thermocouples. The intermediate plate IP can also be equipped with electrical heating elements. The aforementioned heating resistances have the function of heating the raw material necessary for the formation of the wafer; the methods of temperature control are independent of the purposes of the invention.

In the preferential example described below, the mould plates UP and LP are both movable with respect to the mould plate IP, but in other embodiments different type of driving can be provided, for example with one of the plates UP and LP that is in a fixed position, while the plate IP and the other one of the plates UP and LP that are movable.

In the example the intermediate mould plate IP is fixed and the upper mould plate UP and the lower mould LP are linearly movable, and for this purpose they are mechanically coupled to the ends of the through-stems 101 of the upper and lower compression cylinders 100₁ and 100₂, respectively. According to an important aspect, in various preferential embodiments, this mechanical coupling is of an adjustable type, in order to enable a fine or precision adjustment of the operating position of at least one of the plates UP and LP, or of the corresponding dies M, relative to the through openings of the intermediate plate IP. In the case exemplified, the adjustable coupling comprises a part with a male thread F defined or associated with the proximal end of the stem 101 of the cylinder 100₁ and/or 100₂, on which a bushing with a female thread UP₁ or LP 1 is engaged in an adjustable way, used to secure the plate UP or LP, respectively, to the corresponding stem 101.

In various embodiments, a similar adjustment system can be provided between the stem 201 of one or both the displacement cylinders 200₁, 200₂ and the stem of the corresponding compression cylinder 100₁, 100₂. As mentioned, this adjustment possibility enables to accurately establish the position of the dies M with respect to the openings of the intermediate plate IP.

Preferably, in order to ensure the precision of the relative movement between the upper plate UP and the lower plate LP, vertical guide rods 46 are constrained to the upper plate UP, which are slidingly coupled in corresponding through holes of the lower plate LP; a reverse arrangement is obviously possible (i.e., with the rods 46 fixed to the plate LP and passing through holes of the plate UP).

The machine includes a feeding system, for feeding doses of cereal to the processing unit. For this purpose, again in FIGS. 5 and 6, with 47 is indicated a hopper that can be fed with the raw material (hopper 47 is shown in exploded view in FIG. 5). The hopper 47 is secured at the bottom to the guiding plate 36 and has respective outlets to which—in use—the openings of the dosing plate DP are axially aligned, when this plate is brought by the corresponding cylinder 38 in a backward operating position, as explained below.

All parts in contact with the food material are preferably made of stainless steel. Preferably, at least the parts of the moulds intended for contact with food material are coated with titanium.

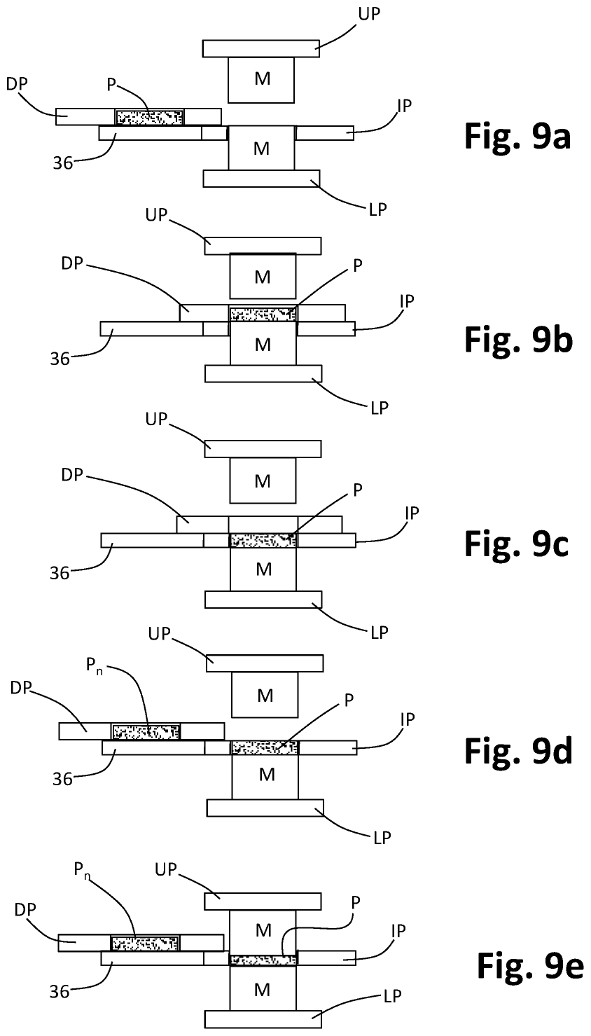

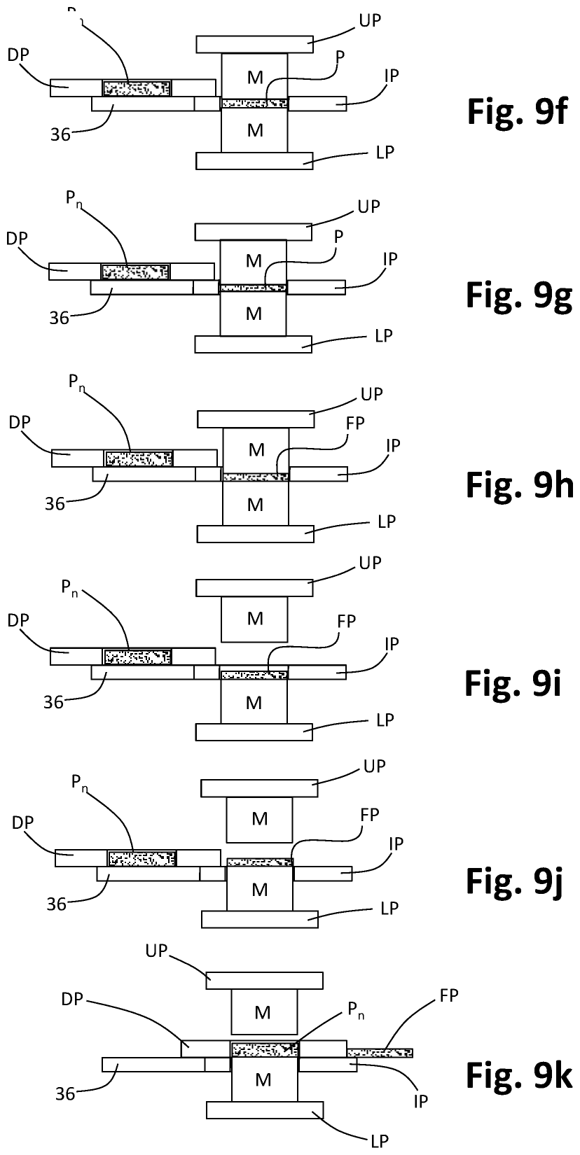

FIG. 8 shows in schematic form way moulding press formed by the plates UP, LP and IP, with the corresponding dosing plate DP. In this figure there are highlighted, compared to what has already been described above, one of the dosing through openings DH of the plate DP and one of the through openings MC of the intermediate plate IP, these openings not being indicated (for representation needs), in the following FIGS. 9a-9k, which exemplify the realization of a rice cake.

FIG. 9a exemplifies a production start-up, where the plate DP is in backward position, in order to receive in the through opening thereof a dose P of raw material, i.e., rice. In the example the lower plate LP is positioned (via the lower displacement cylinder 200₂ previously described) so that the top of the corresponding die or male M, inserted in the respective through opening or female of the intermediate plate IP, is substantially flush with the upper surface of the guiding plate 36, on which the plate DP slides.

FIG. 9b exemplifies the subsequent advancement of the plate DP (obtainable via the cylinder 38 previously described), which brings the dose P to the corresponding female of the intermediate plate IP, i.e., to the top of the male N of the lower plate LP.

FIG. 9c exemplifies the subsequent lowering of the lower plate LP (obtainable via the lower displacement cylinder 200₂ described above), with its male M carrying the dose P therewith by gravity, within the female of the intermediate plate IP, while freeing at the same time the corresponding through opening of the plate DP.

FIG. 9d exemplifies the subsequent retraction of the plate DP (obtainable via the cylinder 38 previously described), with the through opening of the latter that can receive a new dose P˜ of rice.

FIG. 9e exemplifies the subsequent lowering of the upper plate UP (obtainable via the upper displacement cylinder 200₁, previously described), so that the corresponding male M creeps into the female of the intermediate plate IP in which the P dose is located.

FIG. 9f exemplifies the subsequent rising of the lower plate LP (now achievable via the lower displacement cylinder 200₂ described above), so that its male M also creeps into the female of the intermediate plate IP.

FIG. 9g exemplifies the subsequent driving of the upper and lower compression cylinders 100₁ and 100₂ described above, through which the dose is pressed with force, for the set cooking time.

FIG. 9h exemplifies the subsequent lowering of the lower plate LP (now obtainable via the lower displacement cylinder 200₂ previously described), to obtain the expansion of the cake FP.

FIG. 9i exemplifies the subsequent raising of the upper plate UP (now obtainable via the upper displacement cylinder 200₁ previously described), so that the corresponding male M frees the female of the intermediate plate IP, with the cake FP now formed.

FIG. 9j exemplifies the subsequent raising of the lower plate LP (now obtainable via the lower displacement cylinder 200₂ previously described), in order to reach a position corresponding to that of FIG. 9a: hence, the male M carries the cake FP flush with the upper surface of the intermediate plate IP.

FIG. 9k exemplifies the subsequent advancement of the plate DP (obtainable via the cylinder 38 previously described), which brings the new dose P˜ at the female of the intermediate plate IP, or on the top of the male M of the lower plate LP, and at the same time pushes the cake FP beyond the intermediate plate IP for the purpose of its evacuation (i.e., to make it fall on the corresponding slide 30′ of FIGS. 1-3).

The cycle described can be used, for example, for obtaining thicker cakes. For obtaining thinner cakes, for example during the phase referred to in FIG. 9g or FIG. 9h, a further lowering of the upper mould plate UP can be produced, in particular via the upper compression cylinder 100₁, in order to compress the dose of raw material to a greater extent.

Possibly, for the production of thicker cakes, it is also possible to carry out the phases referred to in FIGS. 9h-9i in a single phase, that is, with the lowering of the lower plate LP and the simultaneous rising of the upper plate UP. In order to be able to perform this processing mode, it is particularly advantageous to use devices for adjusting the flow of compressed air from the outlet of the corresponding compression cylinder, which increase or decrease the speed thereof in such a way that the lower and upper males M come out of the female at the same time.

The production of chips, instead of cakes, takes place largely in the same way as described above with reference to FIGS. 9a-9k, but with the substantial difference that—during the phase referred to in FIG. 9g—the lower plate LP is lowered, for a few milliseconds (approximately between 50 and 200 milliseconds), and made to rise a series of times, for example three, in order to reduce the expanding power of the cereal and at the same time give a wavy/irregular shape to the product. Therefore, for the purposes of this processing, a mould opening time parameter (lowering of the plate LP) and three cooking time parameters (closed mould as in FIG. 9g) are set, at the end of which the cooking cycle ends.

The cycle time depends on the type and quantity of cereals used, but also on the temperature setting and the degree of cooking required. In general terms, a work cycle at 245° C. lasts about 8″ using bulk cereals, either whole or broken ones. In the case of use of cereal pellets, the cycle can lower to between 5″ and 7″, depending on the type of pellet used (in this case the temperature must be reduced).

The cereals which can be processed by the described unit 30 are for example whole corn, corn, brown rice, rice, spelt, wheat, barley, in bulk or in pellet form.

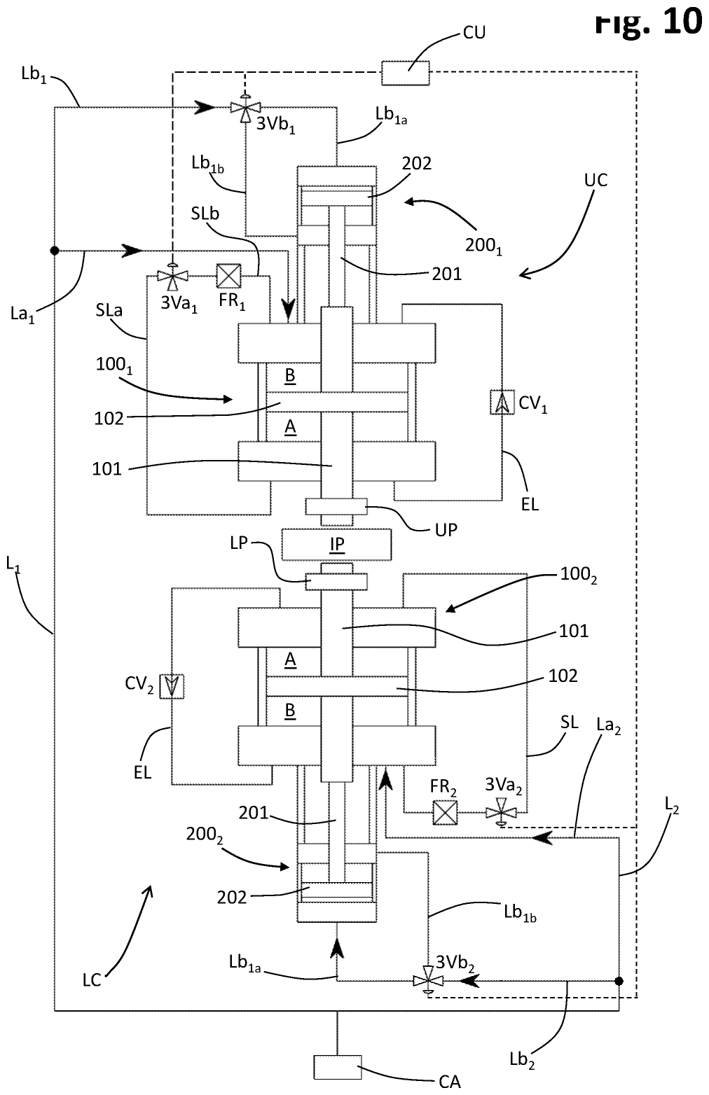

FIG. 10 shows in schematic form the pneumatic circuit of a machine according to possible preferential embodiments of the invention, which includes an upper circuit section UC and a lower circuit section LC, and wherein each section includes the respective compression cylinder 100₁, 100₂ and the respective displacement cylinder 200₁, 200₂.

As also visible in FIG. 5, the plunger 102 of each compression cylinder 100₁, 100₂ has the corresponding stem 101 associated thereto, and to one end (proximal) of this stem the respective upper mould plate UP or lower mould plate LP is coupled, respectively, in order to cooperate with the intermediate mould plate IP, as explained above. At the other (distal) end of the stems 101 (i.e., the one that protrudes outside the cylinders 100₁ and 100₂ in the opposite position with respect to the intermediate plate IP), there is mechanically coupled the end of the stem 201 of the respective displacement cylinder 200₁ or 200₂, associated in turn with the corresponding plunger 202, inside the respective cylinder casing.

As shown in FIG. 10, the two chambers A and B of variable volume inside each compression cylinder 100₁ and 100₂ (i.e., the two chambers separated by the plunger 102) are connected to each other by means of an air recovery duct EL. The two chambers A and B of the cylinders 100₁ and 100₂ are also connected, through the ducts indicated with SLb and SLa, respectively, to a first and a second way of a control valve arrangement 3Va₁ and 3Va₂ (a third way is for the release of air into the environment); on each duct SLb there is a flow-regulator device FR₁ and FR₂, respectively, whose functions will be clarified later.

As it will be seen, the control valve arrangement 3Va₁ or 3Va₂ is controllable for:
enabling a flow of compressed gas between the first chamber A and the second chamber B of the compression cylinder 100₁ or 100₂ when the plunger 102 thereof is displaced by the displacement cylinder 200₁ or 200₂ between the advanced position and the retracted position, and
enabling venting of compressed gas from the first chamber A when the compression cylinder 100₁ or 100₂ has to exert a compression on a dose of cereal.

In the exemplified embodiment, a source of compressed gas AC is provided, which here is supposed to be air, for example, a compressor. From this source AC two branches of the pneumatic circuit depart, indicated with L₁ and L₂, respectively for the upper circuit section UC and the lower circuit section LC.

During operation, the compressed air flowing into the branch L₁ separates into two flows La₁ and Lb₁, in order to supply the cylinders 100₁ and 200₁: the flow Lb₁ supplies the cylinder 200₁ by means of a control valve arrangement 5Vb₁ and two related ducts Lb₁ₐ and Lb_{1b}, connected to the upper and lower chamber of the cylinder itself, respectively. Flow La₁ directly supplies the upper chamber B of cylinder 100₁. Similarly, the compressed air flowing in the branch L₂ is separated into two flows La₂ and Lb₂, in order to supply the cylinders 100₂ and 200₂: the flow Lb₂ supplies the cylinder 200₂ by means of a valve arrangement 5Vb₂ and two related ducts Lb₂ₐ and Lb_{2b}, connected to the upper and lower chamber of the cylinder itself, respectively. The flow La₂ directly supplies the upper chamber B of cylinder 100₂.

The aforementioned valve arrangements 3Va₁, 3Va₂, 5Vb₁ and 5Vb₂ are preferably fast-acting electric control valves, very preferably solenoid valves, the operation of which is managed by the control unit CU. In the figure, the valve arrangements 5Vb₁ and 5Vb₂ are represented for simplicity as three-way valves, but in reality they are preferably five-way valve arrangements, two of which for the release of air into the environment. The valve arrangements 3Va₁ and 3Va₂ are preferably three-way valves, the third of which is for the release of air into the environment. In the following, for simplicity, the valve arrangements will be indicated for simplicity also as valves.

In the upper section UC, the compressed air from the valve 5Vb₁ can supply—via its first way and the duct Lb₁ₐ—the upper chamber of the displacement cylinder 200₁, in order to cause the advancement of the plunger 202, with the associated stem 201; at the same time, via the duct Lb_{1b} and a second and third way of the valve 5Vb₁, from the lower chamber of cylinder 200₁ the relevant air is released into the environment. When it is instead necessary to cause the retraction of the stem 201, via the duct Lb_{1b} and the second way of the valve 5Vb₁, the compressed air is fed into the lower chamber of the cylinder 200₁, and at the same time the air from the upper chamber is released into the environment, through the duct Lb₁ₐ, the first way and a fourth way of the valve 5Vb₁. Similar operation takes place for the displacement cylinder 200₂ in the lower section LC, through the valve 5Vb₂ and the ducts Lb₂ₐ and Lb_{2b}.

As mentioned, the air flow La₁ directly supplies the upper chamber B of the cylinder 100₁, which is therefore constantly kept under pressure. When it is necessary to exert a push via the plunger 102, or the stem 101, the third way of the valve 3Va₁ is opened, in order to release into the environment—through the duct SLa—part of the air present in chamber A. Note that the amount of air released is small, as the stroke required for the cylinder 102 is minimal: as mentioned, the cylinders 100₁ and 100₂ basically have the sole function of pressing the dose of cereal, while the displacement of their plunger is in fact realized through the cylinders 200₁ and 200₂. The retraction of the plunger 102, or stem 101, is obtained through the cylinder 200₁, driven in retraction as described above: in this phase—the valve 3Va₁ connects the ducts SLb and SLb to each other, without release of air. Similar operation takes place in the lower section LC, through the air flow La₂ that directly supplies the chamber B of the cylinder 100₂, the control of which takes place through the valve 3Va₂ and the ducts SLa and SLb.

Hence, summarizing:
by means of the cylinders 200₁ and 200₂ it is possible to obtain the displacement of the stems 101 of the cylinders 100₁ and 100₂ to the operating position, the upper chambers of which B are constantly supplied with compressed air (i.e., with the chambers A and B in equilibrium); during the displacement produced by the cylinder 200₁ or 200₂, the valve 3Va₁ or 3Va₂, respectively, connects the ducts SLa and SLb to each other, so that between the two chambers A and B of the cylinder there is a displacement of air without release into the environment, also due to the duct EL;
when the stems 101 of the cylinders 100₁ and 100₂ are in their respective operating position, through the control described above of the valves 3Va₁ and 3Va₂, respectively, it is possible to obtain the force of thrust required to compress the dose of cereal, with a minimum release of air into the environment from chambers A;
via the cylinders 200₁ and 200₂ it is then possible to move the stems 101 of the cylinders 100₁ and 100₂ to the inoperative position; also in this case, during the displacement phase, the valves 3Va₁ and 3Va₂, respectively, connect the ducts SLa and SLb to each other, so that between the two chambers A and B of the cylinder there is a displacement of air without release into the environment (in this phase the duct EL is not operational, in view of the presence of a corresponding shut-off body, as explained below).

The control unit CU is configured for controlling the valves 3Va₁, 5Vb₁, 3Va₂ and 5Vb₂ in an independent way, so that the pneumatic pressure can be selectively applied to each of the cylinders 100₁, 200₁, 100₂ and 200₂.

The displacement of each plate UP or LP during the opening and closing steps of the mould is therefore carried out through the displacement cylinders 200₁ or 200₂ and the corresponding valves 5Vb₁ or 5Vb₂, respectively, as indicated above.

Thanks to the connection of the stems 201 of the cylinders 200₁ and 200₂ to the stems 102 of the cylinders 100₁ and 100₂, the simple movement of the mould plates UP and LP relative to the intermediate mould plate IP, respectively, is obtained. For this reason, the displacement cylinders 200₁ and 200₂ do not have to exert a considerable force, and can therefore be relatively small in size, and therefore fast. By contrast, once the plates UP and LP have been positioned at the plate IP, it is necessary to develop a significantly greater force, in order to obtain the desired compression of the raw material: for this reason, the cylinders 200₁ and 200₂ are preferably of greater size.

During the operation of the displacement cylinders 200₁ and 200₂ the air is stored inside the compression cylinders 100 1 and 100₂, thanks to the ducts EL and/or SLa-SLb, which connect to each other the corresponding internal chambers A and B, i.e., by recycling the air from one chamber to another during the movements of the plunger 102. As mentioned, for the purposes of the thrust required by each compression cylinder 100₁ or 100₂, the valve 3Va₁ or 3Va₂ enables a modest venting of air from the chamber A. In the return phase of the plunger 102, obtained through the corresponding displacement cylinder 200₁ or 200₂, no air venting from the chamber B is determined, thanks to the ducts SLa, SLb and the valve 3Va₁ or 3Va₂.

According to an important feature, downstream of the valves 3Va₁ and/or 3Va₂, on the respective duct SLb connected to the upper chamber B of the compression cylinder 100 1 or 100₂, a regulator device FR₁ and FR₂ of the air flow is provided. Such a device, for example represented by a tap or the like, is configured or operable for enabling to regulate or choke (partialize) the flow of compressed gas between the first chamber A and the second chamber B when the second plunger 102 is moved by the displacement cylinder 100₁ or 100₂ between the advanced position to the retracted position. The setting of the device FR₁ or FR₂ can be done manually or in a servo-assisted way (through a suitable electric actuator) depending on the type of product to be obtained. The flow regulation operable via the devices FR₁ or FR₂ allows in particular to control the retraction speed of the corresponding cylinder 100₁ or 100₂, and therefore the expansion and the texture of the product to be obtained.

In accordance with an important feature, in combination with the use of the flow-regulator device FR₁ and/or FR₂, a shut-off member is provided on the recovery pipe EL, capable of:
enabling the passage of compressed gas from the first chamber A to the second chamber B when the plunger 102 of the compression cylinder 100₁ or 100₂ is brought by the corresponding displacement cylinder 200₁ or 200₂ from the retracted position to the advanced position, and
prevent the passage of compressed gas from the second chamber B to the first chamber A when the same plunger 102 is brought by the displacement cylinder 200₁ or 200₂ from the advanced position to the retracted position.

In other words, therefore, the aforementioned shut-off member is designed to make the duct EL non-operational during the retraction of the plunger 102 of the cylinder 100₁ or 100₂.

In preferential embodiments, the aforementioned shut-off member comprises a non-return valve, such as those indicated with CV₁ and CV₂, respectively, in FIG. 10. In possible variant embodiments, the non-return valves could be replaced by respective solenoid valves, controlled by the unit CU to close the duct EL during the retraction of the plunger 102 of the cylinder 100₁ or 100₂.

As seen above, the duct EP allows, during the advance phase of the plunger 102 of the compression cylinder 100₁ or 100₂ (caused by the corresponding displacement cylinder 200₁ or 200₂) the recovery of the compressed air contained in the chamber A (i.e., the chamber closest to the corresponding mould plate UP or LP) with a displacement speed of the same plunger which his constant and high. On the other hand, during the retraction phase of the plunger 102 (also caused by the corresponding displacement cylinder 200₁ or 200₂) the provision of the non-return valve CV₁ or CV₂ (or possible solenoid valve) prevents the air from chamber A to chamber B from passing through the corresponding duct EL, with a consequent rapid retraction of the plunger 102, and then of the mould plate UP or LP, which would have negative effects on the expansion and texture of the product, i.e., on its quality.

As a matter of fact, during the retraction of the plunger 102, the presence of the valve CV₁ or CV₂ has the effect of forcing the passage of air from the chamber B to the chamber A through the duct SLb, the regulator device FR1 or FR2, the valve 3Va1 or 3Va2 and the duct SLa: hence, in this phase the device FR₁ or FR₂ comes into play, the adjustment of which allows to slow down more or less the retraction of the plunger 102, and therefore the corresponding displacement of the mould plates UP and LP, in order to obtain the desired quality of the product.

As it can be imagined, the variation of the thickness of the products to be obtained can be obtained by adjusting the maximum forward stroke of the stem 201 of at least one of the displacement cylinders, in particular of the upper cylinder 200₁.

For this purpose, referring in particular to FIG. 5, in various embodiments, at least the stem 201 of the upper cylinder 200₁ is a through-stem, that is, it has a distal end portion 201a always protruding with respect to a distal end surface of the cylinder casing, regardless of the operating position of the corresponding plunger 202.

In solutions of this type, according to an important characteristic, on the distal end portion 201a of the stem 201 of the cylinder 200₁ a mechanical stop element is mounted in a movable way, indicated with 300 in FIG. 5. This mechanical stop element 300 is mounted on the distal end portion 201a by means of an adjustable coupling; this coupling is configured for enabling to vary the working position of the mechanical stop element 300 in the axial direction of the aforementioned distal end portion 201a of the stem 201: in this way it is possible to adjust the maximum forward stroke allowed for the stem 201 of the cylinder 200₁, among a plurality of possible maximum forward strokes, and consequently adjust the advanced position of the plunger 102 of the pneumatic compression cylinder 100₁ among a plurality of possible advanced positions.

In various preferential embodiments the aforementioned adjustable coupling comprises a male thread 201b of the distal end portion 201a of the stem 201, and a female thread 301 of an axial hole of the mechanical stop element 300, in which the aforementioned male thread 201b is engaged. As it can be imagined, through the indicated threaded coupling, by rotating the stop element 300 in one direction or another it is possible to vary the position of the element itself along the end portion 201a of the stem 201. Of course, as is customary in the case of pneumatic cylinders, the stem 201 is prevented from rotating around its longitudinal axis, in view of its fixed coupling to the corresponding plunger 202, which is bound only to linear movement.

In this way, the stop element 300 can be used as a mechanical end-of-stroke that, when the cylinder 200₁ is operated for advancing, abuts against the distal end of the casing of the same cylinder, and can thus limit the stroke allowed for the corresponding stem 201. In other words, in the absence of the stop element 300 (or with that element 300 in an axial position outside the permissible adjustment range), the pneumatic control of the cylinder 200₁ would make it possible to obtain the maximum possible stroke for stem 201; on the other hand, in the presence of the element 300 in its axial position within the permissible adjustment range, the stroke of the stem 201 is more reduced, as it is mechanically limited by the element 300 that abuts on the surface of the distal end of the casing of the cylinder 200₁.

Note that the adjustment range provided for the forward stroke of the stem 201 is relatively limited, approximately between 0 and 30 mm (meaning by this that the theoretical maximum stroke of the stem 201 can be reduced up to a maximum of 30 mm). The displacement of the stop element 300 between the two ends of the intended adjustment range may involve multiple full rotations, or more fractions of a full turn of the element itself, on the end portion 201a of the stem 201: this essentially depends on the pitch chosen for the threads 201b and 301.

In various embodiments, the machine 1, or the processing unit 30, comprises actuator means, designed to vary the working position of the stop element 300 in a motorized way. FIG. 5 exemplifies, for example, the case of actuators means configured to cause the clockwise or counter clockwise rotation, depending on the required adjustment, of the stop element 300 relative to the end portion 201a of the stem of the cylinder 200₁. The actuators means may comprise, for example, a reversible electric motor 400, possibly associated with a corresponding 401 gear reducer.

The motor 400 has preferably a transmission arrangement associated thereto, designed to transfer a rotation produced by a shaft of the motor 400 to the stop element 300. In the example shown, the stop element 300 has peripheral toothing, that is, it is basically configured as a crown, and the aforementioned transmission arrangement comprises a pinion 402 meshed with the aforementioned peripheral toothing of the element 300. In the example, the pinion 402 is constrained to be rotatable according to an axis parallel to the sliding axis of the stem 201, and has a width (height, in the drawing) such as to allow the displacement in an axial direction of the element 300. In order to allow this displacement, the toothing of the element 300 and the toothing of the pinion 402 are configured according to a technique known in the field of sliding couplings under load, for example by providing straight teeth. It should be noted that the shown actuation system, with the corresponding transmission arrangement, is merely illustrative, and that in the practical implementation this system may be differently conceived according to any technique known in the aforementioned field.

Preferably, sensor means are operatively associated to the actuator means, the sensor means being configured to supply information representative of adjustment position of the mechanical stop among a plurality of possible adjustment positions. These sensor means can be of any known type, for example of an encoder or a resolver type and/or integrated in the motor 400 or in the possible gear reducer 401; the control logic of the machine can possibly be configured to determine the position of the element 300 based on the count of the number of revolutions of the shaft of the motor 400.

The sensor means are preferably in signal communication with the control unit CU, and the software of the latter is prearranged in such a way as to enable setting of the desired adjustment of the position of the stop element 300 directly from the user interface of the same unit CU.

In various preferential embodiments, cushioning abutment means are operatively arranged between the stop element 300 and the corresponding distal end surface of the casing of the cylinder 200₁. As mentioned, when the element 300 is positioned within the permissible adjustment range, the element itself is intended to abut against the aforementioned end surface of the casing. For this reason, between the two parts intended to come into contact it is preferable to provide for the aforementioned cushioning abutment means.

Referring to the example in FIG. 5, the cushioning abutment means comprise at least one element of elastic material 302, for example formed from an elastomer material, which is fixed or otherwise associated with the lower or proximal end face of the stop element 300, which is facing the upper or distal end face of the casing of the cylinder 200₁. The elastic element 302 can be of an annular shape, so as to surround the area where the end portion 201a of the stem 200 extends.

Of course it is also possible to provide for an inverted arrangement, that is, with at least one element of elastic material associated with the aforementioned upper face of the cylinder casing, which is facing the lower face of the mechanical stop element 300. It is also possible to provide cushioning abutment means both on the lower face of the element 300 and on the upper face of the cylinder casing.

The proposed adjustment system does not necessarily have to be motorized because, in possible embodiments alternative to that of FIG. 5, the adjustable coupling and/or the stop element 300 can be configured for enabling to manually vary the working position of the element 300.

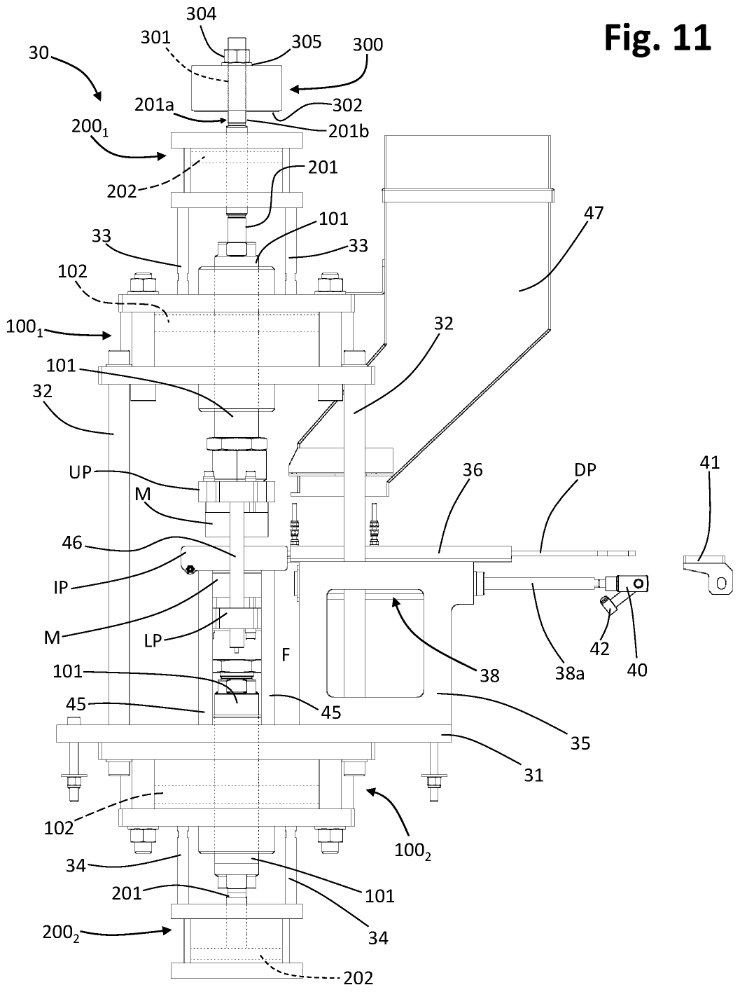

An example of this type is shown in FIG. 11, where the same reference numbers as the previous figures are used, to indicate elements technically equivalent to those already described.

In the case of FIG. 11, the stop element 300 is an element which is manually graspable and operable operated, to cause a clockwise or counter clockwise rotation of the element itself relative to the distal end portion 201a of the stem 201. As it can be imagined, in this case, the element 300 is similar to a nut that can be screwed and unscrewed on the thread 201b of the portion 201a of the stem 201, in order to perform the adjustment.

Preferably, in such a case, the stop element 300 is operatively associated with blocking means, configured to prevent undesired rotations of the element itself relative to the end portion 201a of the stem 201, after the adjustment has been made. In the example shown, the above blocking means comprise a nut 304 or the like, which is screwable and unscrewable on the thread 201b of the end portion 201a of the stem 201, and which essentially performs the function of locknut relative to the stop element 300. In the example shown, the body of the stop element 300 defines an annular part 305 for abutment of the nut 304.

In embodiments of the type in which the adjustment is made manually, as exemplified in FIG. 11, it is preferable to provide for a visible dial, or a similar signalling arrangement, configured for visually indicating the angular position of the stop element 300 among a plurality of possible angular positions, relative to the longitudinal or sliding axis of the stem 201. In this way, the operator in charge has a suitable reference scale for the manual adjustment. The dial or the like can be obtained, for example, on a plate associated with the upper surface of the casing of the cylinder 200₁, or be obtained directly on this surface. For example, in the event that the adjustment involves angular movements of the element 300 equal to a fraction of a complete turn thereof, the dial can provide a plurality of references in different angular positions, arranged according to a circumference, and the stop element 300 will be provided with a suitable index, so that by rotating the element itself the index can be brought to a relative reference, indicative of a corresponding adjustment position.

The characteristics of the present invention are clear from the given description, as are its advantages.

The particular construction of the load-bearing structure of the machine, distinguished by uprights and crossbars, allows to avoid the use of a base with a single columnar supporting element, typical of the prior art. In this way, the processing unit of the machine can be mounted in a condition substantially suspended in a central position of the supporting structure, in the inside thereof, with this structure that is easily equipped peripherally with panels, suitable to contain the dispersion of fumes and/or vapours, as well as scraps and/or processing powders. The structure described also allows to equip the machine with its own dedicated hood, which enables an efficient evacuation of fumes and/or vapours even with limited suction powers (i.e., the hood must not be oversized). The structure also allows to provide the aforementioned collection drawer, in which the scraps and/or processing powders can accumulate by gravity, without dispersion, keeping the working environment clean.

The provision of a quick-change device associated with the dosing plates of the machine processing unit allows the for replacement of this plate in an extremely simple and rapid way, in a time of less than one minute, with significant savings during production changes. The advantage is particularly important at production facilities where several machines operate.

The possibility of adjusting in a simple but extremely precise the mechanical coupling between the stems of the compression cylinders and the corresponding mould plates allows to obtain a high precision of moulding of the snacks. Similar considerations apply in relation to the possibility of adjusting the mechanical coupling between the stems of the displacement cylinders and the stems of the compression cylinders.

The provision of the flow-regulation devices FR₁, FR₂, in combination with the shut-off devices CV₁, CV₂ operating on the ducts EL allows for setting in an easy but precise way the retraction speed of the plungers of the compression cylinders, and therefore of the corresponding mould plates, and hence for controlling the expansion of the product, without the need to intervene on the supply pressure of the cylinders. The possibility of adjustment makes it possible to prevent the compression cylinders from moving back at different speeds, and thus avoid the risk of obtaining different or non-homogeneously expanded products.

The proposed adjustment system allows to easily and precisely adjust the forward stroke of the stem of at least one of the displacement cylinders, and adjust accordingly the position of maximum advancement of the stem of the corresponding compression cylinder, and therefore of the corresponding mould plate. The adjustment can be made in a simple and quick way, even if manual, with this facilitating and making production changes faster. The adjustment system is also constructively simple, even when motorized.

It is clear that numerous variants are possible for the person skilled I the art to the devices and methods described as an example, without departing from the scope of the invention as defined by the attached claims. Individual characteristics described with reference to embodiments described above can be combined with each other in other embodiments.

The stem 201 does not necessarily have to be configured in a single piece, and in this perspective the portion of the distal end previously indicated with 201a can be obtained by an externally threaded component, that is fixed in rotation to a different component, connected to the plunger of the corresponding displacement cylinder.

The cavity of the stop element 300 provided with the female thread 301 does not necessarily have to be a through cavity, since it can in fact be a blind hole, for example in the case of a motorized driving of the type shown in FIG. 5.

The transmission arrangement, designed to transfer a rotation produced by the shaft of the motor 400 to the stop element 300 could be of a different type from the one exemplified, in a manner that appears clear to the skilled person. For example, the motor could be mounted with the shaft in axis with the stop element, (i.e., with the stem 201), with a component associated to the shaft, bearing or defining at least one pin or the like, engaged in a corresponding hole or seat opening at the upper face of the stop element, in an eccentric position: in this way the rotation of the motor shaft causes the rotation of the aforementioned component, and therefore of the stop element fixed in rotation to said component by means of at least one pin or the like.

1. A machine for preparing snacks based on puffed cereals and the like, having a load-bearing structure and a processing assembly which includes at least one processing unit and a feeding system, for feeding cereal doses to the processing unit,
wherein the processing unit comprises an upper mould plate with at least one upper die, a lower mould plate with at least one lower die, and an intermediate mould plate defining at least one through opening in which the upper die and the lower die are at least partially receivable,
wherein the processing unit has an actuation system comprising a source of compressed gas and pneumatic actuator means, controllable to cause relative linear displacements among the upper mould plate, the lower mould plate and the intermediate mould plate, to compress a cereal dose between the upper die and the lower die,
wherein at least one of the upper mould plate, the lower mould plate and the intermediate mould plate has heating means associated thereto,
wherein, for at least one of the upper mould plate and the lower mould plate, the pneumatic actuator means, comprise:
a displacement pneumatic-cylinder having a first plunger connected to a first stem, and
a compression pneumatic-cylinder, having a second plunger connected to a second through-stem,
wherein the first stem has a distal end connected to a proximal end of the second through-stem, to a distal end of the second through-stem there being connected the upper mould plate or the lower mould plate, respectively,
wherein the displacement pneumatic-cylinder is controllable to cause a displacement of the second plunger of the compression pneumatic-cylinder between a retracted position and an advanced position,
wherein the compression pneumatic-cylinder is controllable to exert a compression on a cereal dose after the second plunger has been brought into said advanced position,
wherein the second plunger delimits in the compression pneumatic-cylinder a first chamber of variable volume, closer to the upper mould plate, respectively to the lower mould plate, and a second chamber of variable volume, farther from the upper mould plate, respectively from the lower mould plate,
wherein the second chamber is connected in fluid communication with the source of compressed gas via a first duct,
wherein the first chamber is selectively connectable to the second chamber through a second duct on which a respective control valve-arrangement is operatively set,
wherein the first chamber is also connected to the second chamber (B) via a third duct,
wherein the control valve-arrangement is controllable for:
enabling a flow of compressed gas between the first chamber and the second chamber when the second plunger is displaced by the displacement pneumatic-cylinder between the advanced position and the retracted position, and
enable venting of compressed gas from the first chamber when the compression pneumatic-cylinder has to exert a compression on a cereal dose,
wherein on the second duct is also operationally set a flow-regulator device, configured for regulating or choking the flow of compressed gas between the first chamber and the second chamber when the second plunger is displaced by the displacement pneumatic-cylinder between the advanced position and the retracted position,
wherein a shut-off member is operatively set on the third duct, capable of:
enabling passage of compressed gas from the first chamber to the second chamber when the second plunger is brought by the displacement pneumatic-cylinder from the retracted position to the advanced position, and
preventing passage of compressed gas from the second chamber to the first chamber when the second plunger is brought by the displacement pneumatic-cylinder from the advanced position to the retracted position.

2. The machine according to claim 1, wherein the shut-off member comprises a non-return valve.

3. The machine according to claim 1, wherein the control valve-arrangement comprises an electric three-way valve.

4. The machine according to claim 1, also comprising a further control valve-arrangement for controlling the displacement pneumatic-cylinder, the further control valve-arrangement being operatively set between the source of compressed gas and the displacement pneumatic-cylinder.

5. The machine according to claim 4, wherein:
the first plunger delimits in the displacement pneumatic-cylinder a respective first chamber of variable volume, closer to the upper mould plate, respectively to the lower mould plate, and a respective second chamber of variable volume, farther from the upper mould plate, respectively from the lower mould plate,
the further control valve-arrangement comprises an electric five-way valve, controllable for:
connecting the source of compressed gas to said respective second chamber and enabling at the same time venting of compressed gas from said respective first chamber, when the first plunger is displaced from a respective retracted position to a respective advanced position, and
connecting the source of compressed gas to said respective first chamber and enabling at the same time venting of compressed gas from said respective second chamber, when the second plunger is displaced from the respective advanced position to the respective retracted position.

6. The machine according to claim 1, wherein the distal end of the first stem is mechanically connected in an adjustable way to the proximal end of the second through-stem.

7. The machine according to claim 1, wherein the proximal end of the second through-stem is mechanically connected in an adjustable way to the upper mould plate, respectively to the lower mould plate.

8. The machine according to claim 1, wherein the flow-regulator device is a device operable in a manual way or else in a servo-assisted way, via an electric actuator.

9. The machine according to claim 1, wherein the pneumatic actuator means of the upper mould plate and of the lower mould plate each comprise one said displacement pneumatic-cylinder, one said compression pneumatic-cylinder, one said first duct, one said second duct with respective control valve-arrangement and flow-regulator device, and one said third duct with respective shut-off member.

10. A machine for preparing snacks based on puffed cereals and the like, having a load-bearing structure and a processing assembly which includes at least one processing unit and a feeding system, to feed cereal doses to the processing unit,
wherein the processing unit comprises an upper mould plate with at least one upper die, a lower mould plate with at least one lower die, an intermediate mould plate, defining at least one through opening in which the upper die and the lower die are at least partially receivable,
wherein the processing unit further comprises actuator means controllable for causing relative linear displacements among the upper mould plate, the lower mould plate and the intermediate mould plate, to compress a cereal dose between the upper die and the lower die,
wherein at least one of the upper mould plate, the lower mould plate and the intermediate mould plate has heating means associated thereto,
wherein the load-bearing structure includes a plurality of upright structural elements connected in a lower region thereof by means of a plurality of lower transverse structural elements and connected in an upper region thereof by means of a plurality of upper transverse structural elements,
wherein the upright structural elements are also connected, in an intermediate region thereof, by means of a plurality of intermediate transverse structural elements, which obtain an anchoring and supporting structure,
wherein the processing unit has a respective load-bearing structure which is fixed to the anchoring and supporting structure and is configured in such a way that the processing unit is suspended with respect to the anchoring and supporting structure,
and wherein a plurality of substantially closed peripheral panels is associated to the load-bearing structure, in a position corresponding to at least one of:
a lower zone, substantially comprised between the lower transverse structural elements and the intermediate transverse structural elements,
an upper zone, substantially comprised between the upper transverse structural elements and the intermediate transverse structural elements,
wherein the plurality of peripheral panels comprises lower panels at said lower zone, the lower panels being designed to contain dispersion of cereal scraps and/or powders produced during operation of the processing unit,
wherein the machine further comprises a lower collecting drawer, for accumulating the cereal scraps and/or powders, which is arranged in the lower zone underneath the processing unit,
and wherein deflector elements are associated to the load-bearing structure, configured for conveying the cereal scraps and/or powders towards the inside of the collecting drawer, each deflector element defining a chute or an inclined plane and being mounted higher than the collection drawer.

11. The machine according to claim 10, wherein the plurality of peripheral panels comprises upper panels at said upper zone, the upper panels being designed to contain dispersion of fumes and/or cooking vapours that develop during operation of the processing unit.

12. (canceled)

13. (canceled)

14. (canceled)

15. The machine according to claim 10, wherein at least two sliding guides for the collecting drawer are associated to the load-bearing structure of the machine.

16. (canceled)

17. (canceled)

18. (canceled)

19. (canceled)

20. A machine for the preparation of snacks based on puffed cereals and the like, having a load-bearing structure and a processing assembly which includes at least one processing unit and a feeding system, to feed a cereal to the processing unit,
wherein the processing unit comprises an upper mould plate with at least one upper die, a lower mould plate with at least one lower die, an intermediate mould plate, defining at least a first through opening in which the upper die and the lower die are at least partially receivable,
wherein the processing unit further comprises first actuator means controllable for causing relative linear displacements among the upper mould plate, the lower mould plate and the intermediate mould plate, to compress a dose of cereal between the upper die and the lower die,
wherein at least one of the upper mould plate, the lower mould plate and the intermediate mould plate has heating means associated thereto,
wherein the processing unit further comprises a dosing plate, defining at least one second through opening, the dosing plate being displaceable between:
a backward position, in which the second through opening receives a dose of cereal from the feeding system, and
a forward position, in which the second through opening is axially aligned with the first through opening of the intermediate mould plate, to position the dose of cereal therein,
wherein the processing unit also comprises second controllable actuator means to cause to-and-fro linear displacements of the dosing plate between the backward position and the forward position,
wherein the second actuator means comprise a linear actuator having a stem to which the dosing plate is constrained by means of a mechanical-coupling device,
wherein the dosing plate is of a replaceable type, and the mechanical-coupling device comprises a quick-change device.

21. (canceled)

22. The machine according to claim 20, wherein the quick-change device comprises:
one first quick-change element associated to the stem of the linear actuator and having at least one first passage,
a second quick-change element associated to the dosing plate and having at least one second passage,
a locking member having a pin portion engageable in a removable way in the at least one first passage and in the at least one second passage, to constrain in a separable way the first quick-change element and the second quick-change element,
wherein the locking member further has a coupling portion which is elastically or snap engageable and disengageable with respect to one of the first quick-change element, the second quick-change element and the stem of the linear actuator, to prevent unwanted slipping of the pin portion of the locking member from the at least one first passage and from the at least one second passage,
and wherein the coupling portion of the locking member is elastically or snap engageable and disengageable with respect to one of the first quick-change element, the second quick-change element and the stem of the linear actuator following a stress on the locking member such as to induce a rotation of the pin portion within the at least one first passage and the at least one second passage.

23. The machine according to claim 22, wherein:
the first quick-change element comprises a fork element having two parallel arms, the at least one first passage comprising mutually aligned holes of the two parallel arms,
the second quick-change element comprises a bracket having an engaging portion that is receivable between the two parallel arms of the fork element, the at least one second passage comprising an opening of the engaging portion suitable to be aligned with said holes,
in such a way that between said holes and opening the pin portion of the locking member is receivable.

24. (canceled)

25. (canceled)

26. (canceled)

27. (canceled)

28. (canceled)

29. (canceled)

30. A machine for preparing snacks based on puffed cereals and the like, having a load-bearing structure and a processing assembly which includes at least one processing unit and a feeding system, for feeding cereal doses to the processing unit,
wherein the processing unit comprises an upper mould plate with at least one upper die, a lower mould plate with at least one lower die, and an intermediate mould plate defining at least one through opening in which the upper die and the lower die are at least partially receivable,
wherein the processing unit has an actuation system comprising a source of compressed gas and pneumatic actuator means, controllable to cause relative linear displacements among the upper mould plate, the lower mould plate and the intermediate mould plate, to compress a cereal dose between the upper die and the lower die,
wherein, for at least one of the upper mould plate and the lower mould plate, the pneumatic actuator means, comprise:
a displacement pneumatic-cylinder having a first plunger which is displaceable within a first cylinder casing and which is connected to a first stem, and
a compression pneumatic-cylinder, having a second plunger which is displaceable within a second cylinder casing and which is connected to a second through-stem,
wherein the first stem has a proximal end connected to a distal end of the second through-stem, to a proximal end of the second through-stem there being connected the upper mould plate or the lower mould, respectively,
wherein the displacement pneumatic-cylinder is controllable to cause a displacement of the second plunger of the compression pneumatic-cylinder between a retracted position and at least one advanced position,
wherein the compression pneumatic-cylinder is controllable to exert a compression on a cereal dose after the second plunger has been brought into said advanced position,
wherein the first stem of the displacement pneumatic-cylinder is a through-stem and has a distal end portion which protrudes with respect to a distal end surface of the first cylinder casing irrespective of the operating position of the first plunger,
wherein on the distal end portion of the first stem a mechanical stop element is mounted in a displaceable way, by means of an adjustable coupling,
and wherein the adjustable coupling is prearranged for enabling to vary a working position of the mechanical stop element in an axial direction of the distal end portion of the first stem, to thereby enabling adjustment of a maximum forward stroke of the first stem among a plurality of possible maximum forward strokes, and hence enabling adjustment of an advanced position of the second plunger of the compression pneumatic-cylinder among a plurality of possible advanced positions.

31. (canceled)

32. (canceled)

33. The machine according to claim 30, wherein the adjustable coupling comprises a male thread of the distal end portion of the first stem and a female thread of an axial hole of the mechanical stop element, in which the male thread is engaged.

34. The machine according to claim 33, comprising actuator means which are configured for causing a clockwise rotation, respectively a counter clockwise rotation, of the mechanical stop element relative to the distal end portion of the first stem.

35. (canceled)

36. (canceled)

37. The machine according to claim 31, wherein the actuator means have operatively associated thereto sensor means, configured for supplying information representing an adjustment position of the mechanical stop element among a plurality of possible adjustment positions.

38. (canceled)

39. (canceled)

40. (canceled)

41. (canceled)

42. The machine according to claim 30, wherein cushioning abutment means are operatively arranged between the mechanical stop element and a corresponding distal end surface of the first cylinder casing, the cushioning abutment means comprising at least one of the following:
at least one element made of elastic material associated to a proximal end face of the mechanical stop element which faces a distal end face of the first cylinder casing,
at least one element made of elastic material associated to a distal end face of the first cylinder casing which faces a proximal end face of the mechanical stop element.

43. (canceled)
